(19) United States
(12) Patent Application Publication
(10) Pub. No.: US 2015/0305358 A1
(43) Pub. Date: Oct. 29, 2015

(54) DAIRY PRODUCTS COMPRISING VITAMIN D AND PROCESS FOR MAKING THE SAME

(71) Applicant: Lallemand Specialties Inc., Milwaukee, WI (US)

(72) Inventor: William K. Vanderkooi, Abbotsford (CA)

(21) Appl. No.: 14/260,735

(22) Filed: Apr. 24, 2014

(51) Int. Cl. A23C 7/00; A23K 1/16; A23C 9/123; A23K 1/18; A23C 19/00

(52) U.S. Cl. CPC A23C 7/00; A23K 1/1813; A23C 19/00; A23C 9/123; A23K 1/1603

(57) ABSTRACT

Methods are provided for manufacturing dairy products comprising vitamin D. In general, the methods can include feeding dairy animals with a feed composition comprising a dairy animal feed and inactive yeast comprising vitamin D2. Milk produced by the dairy animals is thereby provided which can include an increased vitamin D content. In some embodiments, milk produced by the dairy animals can be processed to form a dairy product comprising vitamin D.

### FIELD OF THE INVENTION

The present application relates to dairy products. More specifically to methods of manufacturing dairy products comprising vitamin D and dairy products made therefrom.

### BACKGROUND OF THE INVENTION

Vitamin D plays an essential role in the health of both humans and animals. Humans are capable of producing vitamin D, specifically vitamin D3, when exposed to UV radiations from sunlight. It was already known and widely accepted in the 1930s that milk, both cows and human, is insufficiently supplied with vitamin D to meet the requirements for good health and to provide anti-rachitic properties. Many attempts have been made to increase the vitamin D content of milk including feeding the cows with irradiated inactive yeast. However, this method has not, to the knowledge of the inventors, been used in 80 years for the industrial production of vitamin D milk.

Also, vitamin D in the form of either ergocalciferol (vitamin D2) or cholecalciferol (vitamin D3) has long been added to milk to assure adequate nutrition supply. Historically, due to importance of milk in the daily diet, consumers traditionally obtained sufficient amounts of vitamin D through their daily milk consumption. As a result, there was little incentive to investigate or improve the fortification of other foods for mass consumption. Recently, with individuals spending less time in direct sun exposure and consuming less milk, especially amongst adults, these sources of vitamin D have become insufficient to provide for the vitamin D levels necessary for good health.

As a result, the interest for fortified dairy products, such as, for example, cheeses and yogurt is growing in popularity. Several approaches have been proposed to provide fortified cheese. Currents methods for supplementing cheese products add the supplement in-situ to the fermenting dairy composition. However, fortifying cheese in this manner often results in large quantities of the supplement being lost in the whey stream rather than being retained in the curd. Many attempts were made to reduce the quantity of supplement lost in the whey stream, but without much success.

Other fortification methods are known, but require additional processing steps. In one of these methods, the supplement is a barrier coated on a surface of the cheese product. However, it would not be desirable to subject cheese to a heating step because the high temperature required for barrier coating may adversely affect the cheese quality or appearance. In another method, the cheese is shredded to accept the supplement followed by a blending of the cheese shreds and the supplement, and then compressing the coated cheese shreds back into a homogenous mass.

Similarly, currents methods for supplementing yogurt add the supplement in-situ to the fermenting dairy composition or to the yogurt base.

Lastly, other methods include manufacturing dairy products with vitamin D-fortified milk. The vitamin D is generally added to milk after the separation of milk fat and before homogenization, the mixing process that keeps milk fats from rising to the top of the liquid. However the final product does not contain as much vitamin D as fluid milk alone.

There is therefore a need for an improved method of manufacturing dairy products comprising vitamin D that has a satisfactory level of vitamin D in the final products necessary for good health.

### SUMMARY OF THE DISCLOSURE

In an aspect, there is provided a method of manufacturing a dairy product comprising vitamin D, the method comprising the steps of providing milk from dairy animals fed with a feed composition comprising a dairy animal feed and inactive yeast comprising vitamin D; and processing the milk to form the dairy product comprising vitamin D.

In another aspect, there is provided a method of increasing vitamin D content in a dairy product. The method comprises orally administrating a feed composition comprising a dairy animal feed and inactive yeast comprising vitamin D2 to dairy animals. The milk obtained from dairy animal fed with the feed composition may be further processed to form the dairy product.

In an aspect of the methods herein described, the dairy product is cheese, yogurt, cream cheese, cream, butter, ice cream or any other dairy product.

In a further aspect, there is provided a method of manufacturing cheese comprising vitamin D, the method comprising the steps of coagulating milk from dairy animals fed with a feed composition comprising a dairy animal feed and inactive yeast comprising vitamin D2 to form a curd-whey mixture; and separating the curd from the curd-whey mixture to form the cheese comprising vitamin D.

In an aspect of the method for manufacturing cheese, the curd-whey mixture is used as is to form the cheese comprising vitamin D.

In an aspect of the method for manufacturing cheese, the method further comprises a step of cooking the curd to form the cheese comprising vitamin D.

In a further aspect of the method for manufacturing cheese, the method further comprises a step of acidifying the milk prior to the coagulation step.

In another aspect, there is provided a method of manufacturing yogurt comprising vitamin D, the method comprising the steps of fermenting milk from dairy animals fed with a feed composition comprising a dairy animal feed and inactive yeast comprising vitamin D2 to form the yogurt comprising vitamin D.

In a further aspect, there is provided dairy product comprising vitamin D, made with milk from dairy animals fed with a feed composition comprising a dairy animal feed and inactive yeast comprising vitamin D2, for human nutrition with vitamin D content compatible with the regulatory requirements of daily vitamin D uptake from the diet. The dairy product is cheese, yogurt, cream cheese, cream, butter or ice cream.

### DESCRIPTION OF THE DRAWINGS

FIG. 1 illustrates a method for producing a dairy product comprising vitamin D in accordance with an embodiment of the invention;

FIG. 2 illustrates a method for producing cheese comprising vitamin D in accordance with an embodiment of the invention;

FIG. 3 illustrates a method for producing a dairy product comprising vitamin D in accordance with another embodiment of the invention.

### DETAILED DESCRIPTION

Milk is not a sufficiently rich source of vitamin D. Consequently it is customary to enrich milk with vitamin D in amount such the milk contain not less than 400 IU of vitamin per liter. Vitamin D is commonly added to milk in its crystalline form. It is also customary to fortify dairy products with vitamin D because dairy products made with vitamin D-fortified milk do not contain as much vitamin D as the milk alone. The methods described herein eliminate the problems associated with fortification of dairy products and eliminate the need to use costly and complex operations. Moreover, the methods herein allow satisfactory amounts of vitamin D to be delivered per serving of dairy product.

Therefore, the present application provides methods of manufacturing dairy products comprising vitamin D and the resulting dairy products.

Reference will now be made to the embodiments illustrated in the drawings and described herein. It is understood that no limitation of the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

The term “inactive yeast comprising vitamin D2” when used herein will be understood to refer to yeast that has been exposed to UV light for the purpose of increasing the vitamin D2 content therein. The yeast may be inactivated by heat or other means known to the person skilled in the art. Methods for obtaining the UV treated inactivated yeast comprising vitamin D2 are disclosed in WO 2008/049232, and herein incorporated by reference.

The inactive yeast comprising vitamin D2 may be yeast from the genus Saccharomyces or any non-Saccharomyces yeast. The non-Saccharomyces yeast is selected from the group consisting of Candida sp, Hanseniaspora sp, Hansenula sp, Kluyveromyces sp, Metschnikowia sp, Pichia sp, Starmerella sp and Torulaspora sp. Preferably, the yeast is Saccharomyces cerevisae or Cyberlindnera jadinii (Torula yeast).

The term “dairy products” when used herein will be understood to refer to food products produced from the milk of dairy animals such as cows, buffalo, goat and sheep.

The term “vitamin D” when used herein will be understood to include vitamin D2, vitamin D3, and 25 hydroxy vitamin D [25(OH) D].

In an embodiment, there is provided a method of increasing vitamin D content in a dairy product. The method comprises orally administrating a feed composition comprising a dairy animal feed and inactive yeast comprising vitamin D2 to dairy animals. The milk obtained from dairy animal fed with the feed composition can be further processed to form the dairy product.

In another embodiment, there is also provided a dairy product comprising vitamin D made with milk from dairy animals fed with a feed composition comprising a dairy animal feed and inactive yeast comprising vitamin D2. In an embodiment, the dairy product may be cheese, yogurt, cream cheese, cream, butter, ice cream or any other dairy product. In an embodiment, the dairy product is cheese. It is understood that the cheese may be any type of cheese such as, for example, hard cheese, soft cheese, mouldy cheese, fresh cheese, brined cheese, process cheese and the like. It is understood that the cheese is not limited to a particular type of cheese. In another embodiment, the dairy product is yogurt. It is understood that the above dairy products are not limited to these examples.

The dairy animal feed may comprise, for example, corn silage, grass round bale silage, PMR mash, and a Robot pellet. The mash and pellet may comprise barley grain, corn distillers, canola meal, nutriments, beet pulp, fat, minerals and vitamins. No other additives such as antibiotic, ionophores, direct fed microbial, enzymes or the likes are added to the feed composition. The inactive yeast comprising vitamin D2 can be mixed with the dairy animal feed according to method known to on skill in the art.

Vitamin D2 values of the dairy product made in accordance with the present disclosure are presented as a percentage of the Daily Value (DV) per serving of the dairy products. The Daily value for vitamin D is defined as 200 IU in the Section 6.3.2 of the Guide to Food Labeling and Advertising from the Canadian Food Inspection Agency. The term “serving” as used herein for dairy products refers to serving size as defined by Health Canada and the Canadian Food Inspection Agency. The serving size of cheese can be, for example, between about 15 g and about 60 g. The serving size for yogurt can be, for example, between about 125 g and about 225 g.

Therefore, in an embodiment, the dairy product comprises at least 10%; 15%; 20%; 25%; 30%; 35%; 40%; 45%; 50%; 55%; 60%; 65%; 70%; 75%; 80%; 85%; 90%; 95% or 100% of the Daily Value of vitamin D per serving. In an embodiment, the dairy product comprises between about 10% and about 100%, between about 15% and about 100% between about 20% and about 100%, between about 25% and about 100%, between about 30% and about 100%, between about 35% and about 100%, between about 40% and about 100%, between about 45% and about 100%, between about 50% and about 100%, between about 55% and about 100%, between about 60% and about 100%, between about 65% and about 100%, between about 70% and about 100%, between about 75% and about 100%, between about 80% and about 100%, between about 85% and about 100%, between about 90% and about 100% or between about 95% and about 100% of the Daily Value of vitamin D per serving. In another embodiment, the dairy product comprises about 100% of the Daily Value of vitamin D per serving.

In order to meet the above defined percentage of Daily Value (% DV) of vitamin D per serving of dairy product made in accordance with the present disclosure, each dairy animal can be fed with a daily dose of vitamin D2 from inactive yeast comprising vitamin D2 (mixed with the dairy animal feed). This daily dose of vitamin D2 from inactive yeast comprising vitamin D2 can be at least 650 000 IU, 675 000 IU, 700 000 IU, 725 000 IU, 750 000 IU, 775 000 IU, 800 000 IU, 825 000 IU, 850 000 IU, 875 000 IU, 900 000 IU, 925 000 IU, 950 000 IU, 975 000 IU or 1 000 000 IU. In another embodiment, the daily dose of vitamin D2 from inactive yeast comprising vitamin D2 can be between about 650 000 IU and about 1 000 000 IU, between about 675 000 IU and about 1 000 000 IU, between about 700 000 IU and about 1 000 000 IU, between about 725 000 IU and about 1 000 000 IU, between about 750 000 IU and about 1 000 000 IU between about 775 000 IU and about 1 000 000 IU, between about 800 000 IU and about 1 000 000 IU, between about 825 000 IU and about 1 000 000 IU, between about 850 000 IU and about 1 000 000 IU, between about 875 000 IU and about 1 000 000 IU, between about 900 000 IU and about 1 000 000 IU, between about 925 000 IU and about 1 000 000 IU, between about 950 000 IU and about 1 000 000 IU or between about 975 000 IU and about 1 000 000 IU. In a further embodiment, the daily dose of vitamin D2 from inactive yeast comprising vitamin D2 can be about 1 000 000 IU. It should be appreciated that the daily dose can vary within the limits set forth above depending on the dairy animal species and/or the dairy animal metabolism.

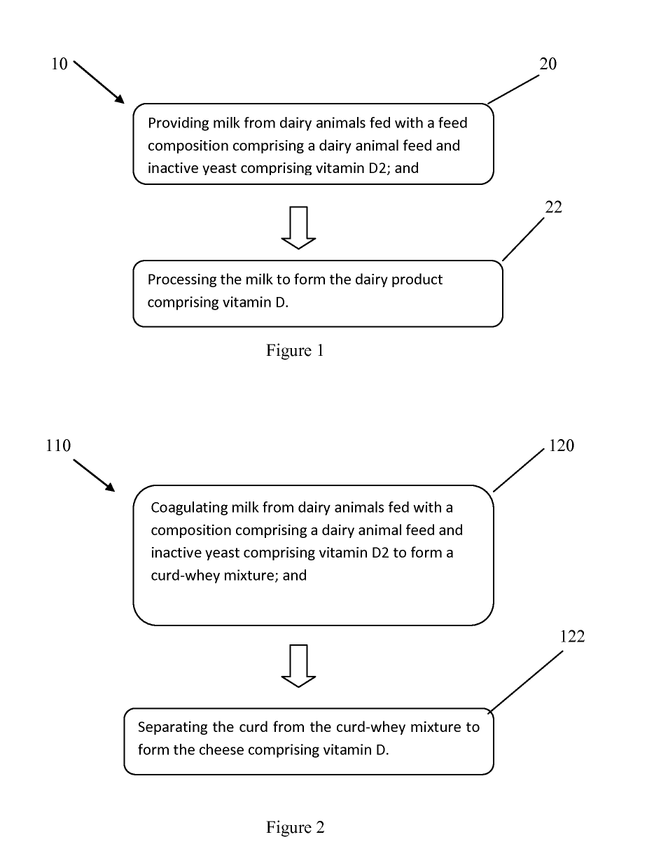

Referring to FIG. 1, a method 10 of manufacturing a dairy product comprising vitamin D in accordance with the present disclosure is shown. In step 20, the method 10 comprises providing milk from dairy animals fed with a feed composition comprising a dairy animal feed and inactive yeast comprising vitamin D2.

In step 22, the milk obtained from step 20 is processed to form the dairy product comprising vitamin D. The dairy product comprising vitamin D is as defined above. It is understood that any suitable techniques and/or processes for the purpose of forming the dairy product may be used.

Turning to FIG. 2, a method 110 of manufacturing cheese comprising vitamin D in accordance with the present application is shown. In step 120, the method 110 comprises coagulating milk from dairy animals fed with a composition comprising a dairy animal feed and inactive yeast comprising vitamin D2 to form a curd-whey mixture.

In an embodiment, the milk may be coagulated with a milk-curdling enzyme, an added acid, lactic acid from bacterial fermentation or combinations thereof. The milk-curdling enzyme may be, for example, rennet from animal source, vegetable rennet, microbial rennet or chymopsin. The added acid may be acetic acid, citric acid, adipic acid, fumaric acid, glucono-delta-lactone, hypochloric acid, lactic acid, malic acid, phosphoric acid, succinic acid or tartaric acid. It is understood that any suitable starter culture may be used for the purpose of lactic acid coagulation of milk in the present application. In an embodiment, the milk may be acidified first with the added acid or from the lactic acid from the bacterial fermentation, and then coagulated with the milk-curdling enzyme. In another embodiment, the milk is acidified with the added acid followed by coagulation with the milk-curdling enzyme. In a further embodiment, the milk is acidified with lactic acid from bacterial fermentation followed by coagulation with milk-curdling enzyme.

It is understood that the skilled person in the art of making cheese will know the milk temperature requirements for such coagulation, depending on the above coagulation methods he uses.

In step 122, the curd is separated from the curd-whey mixture obtained from step 120 to form the cheese comprising vitamin D. The curd may be separated from the whey using any of the methods and techniques known to the skilled person in the art. Alternatively, the curd-whey mixture obtained from step 120 may be used as is to form the cheese comprising vitamin D. An example of cheese made with the curd-whey mixture described above includes, for example, cottage cheese.

In an embodiment, the separated curd obtained from step 122 may be cooked to form the cheese comprising vitamin D. An example of such cheese comprises Cheddar. It is understood that the skilled person in the art of making cheese will know the cooking requirements for expelling more whey, depending on the type of cheese he wants to obtain. In an embodiment, the curd may be cooked with additional ingredients such as, for example, herbs, fruits, walnuts and cumin. It is understood that any suitable ingredients may be incorporated with the curd for the purpose of manufacturing the cheese.

Alternatively, the separated curd obtained from step 122 may be used as is to form the cheese comprising vitamin D. An example of such cheese made with the curd used as is comprises fresh cheeses such as, for example, Mozzarella. It is understood that the cheeses are not limited to these examples.

In an embodiment of the method 110, the method 110 may further comprises a step of inoculating the separated curd with Penicillium mold spores to form a blue cheese comprising vitamin D. The Penicilium mold spores may be Penicillium roqueforti or Penicillium glaucum. It is understood that any suitable mold spores may be used for the purpose of manufacturing blue cheese in accordance with the present application.

In an embodiment, the cheese comprises at least 10%; 15%; 20%; 25%; 30%; 35%; 40%; 45%; 50%; 55%; 60%; 65%; 70%; 75%; 80%; 85%; 90%; 95% or 100% of the Daily Value of vitamin D per serving. In an embodiment, the cheese comprises between about 10% and about 100%, between about 15% and about 100% between about 20% and about 100%, between about 25% and about 100%, between about 30% and about 100%, between about 35% and about 100%, between about 40% and about 100%, between about 45% and about 100%, between about 50% and about 100%, between about 55% and about 100%, between about 60% and about 100%, between about 65% and about 100%, between about 70% and about 100%, between about 75% and about 100%, between about 80% and about 100%, between about 85% and about 100%, between about 90% and about 100% or between about 95% and about 100% of the Daily Value of vitamin D per serving. In another embodiment, the cheese comprises about 100% of the Daily Value of vitamin D per serving.

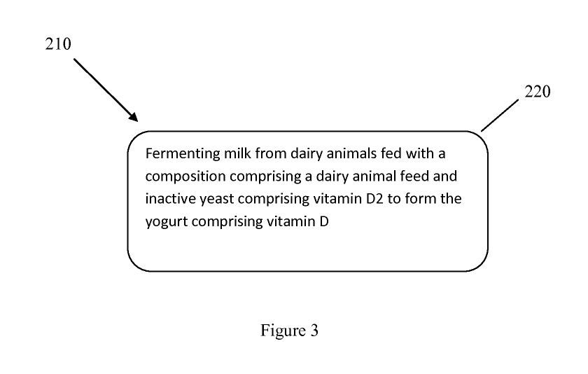

Referring now to FIG. 3, a method 210 of manufacturing another type of dairy product comprising vitamin D, namely yogurt, in accordance with the present application is shown. In step 220, the method 210 comprises fermenting milk from dairy animals fed with a composition comprising a dairy animal feed and inactive yeast comprising vitamin D2 to form the yogurt comprising vitamin D. The dairy animal and the inactive yeast comprising vitamin D2 are as defined above. The yogurt may be a set yogurt, a stirred yogurt, a fruit yogurt, a drinkable yogurt or combination thereof.

Milk is generally fermented using culture of Lactobacillus delbrueckii subsp. bulgaricus and/or Streptococcus thermophilus bacteria. It is understood that any suitable culture may be used for the purpose of manufacturing yogurt in accordance with the present application. In an embodiment lactobacilli and/or bifidobacteria may be added during or after fermenting the milk.

In an embodiment, the yogurt comprises at least 10%; 15%; 20%; 25%; 30%; 35%; 40%; 45%; 50%; 55%; 60%; 65%; 70%; 75%; 80%; 85%; 90%; 95% or 100% of the Daily Value of vitamin D per serving. In an embodiment, the yogurt comprises between about 10% and about 100%, between about 15% and about 100%, between about 20% and about 100%, between about 25% and about 100%, between about 30% and about 100%, between about 35% and about 100%, between about 40% and about 100%, between about 45% and about 100%, between about 50% and about 100%, between about 55% and about 100%, between about 60% and about 100%, between about 65% and about 100%, between about 70% and about 100%, between about 75% and about 100%, between about 80% and about 100%, between about 85% and about 100%, between about 90% and about 100% or between about 95% and about 100% of the Daily Value of vitamin D per serving. In another embodiment, the yogurt comprises about 100% of the Daily Value of vitamin D per serving.

In a further embodiment, a feed composition comprising a dairy animal feed and inactive yeast comprising vitamin D2 is provided. The composition may further comprise other functional ingredients such as, for example omega 3 fatty acids from flaxseed or fish meal. The composition may be used in the diet of dairy animals to increase the vitamin D content of dairy products. It is understood that the feed composition may also be use in the diet of dairy and non dairy animals as a dietary supplement. In an embodiment, the non dairy animals may be bovine, porcine, avian, equine, ovine, lapine, caprine, dogs and cats. Preferably, the avian are chicken, turkey, duck, goose, pheasant, quail or companion birds. In another embodiment, the dairy animal may be cows, buffalo, goat or sheep.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and as may be applied to the essential features hereinbefore set forth, and as follows in the scope of the appended claims.

### EXAMPLES

### Example 1

### Effect of UV Treated Inactivated Yeast Comprising Vitamin D2 Supplementation in the Diet of Lactating Cows on the Vitamin D2 Content of Milk

Pre-trial start date: Dec. 1, 2010, where 45 cows were fed a control ration with no inactive yeast comprising vitamin D2. Study start date: Jan. 1, 2011: the first treatment ration was fed containing 100,000 IU/cow/day of vitamin D2 from inactive yeast comprising vitamin D2. Study end date: Nov. 7, 2013: after 12 months at 1 000 000 IU/cow/day.

Materials

| | |
|---|---|
| Animals: 45 lactating cows | Breed: Holstein lactating |
| Stage of lactation: avg 200 days in milk (DIM) | Parity: 3^{rd} lactation. |

Cows were housed in a free run, free stall (48 stalls), and naturally ventilated barn. Space at the bunk is 2.5 feet/cow. Cows were milked an average of 2.75 times per day.

The study provided a whole herd with vitamin D2 source supplementation and compared milk from the whole herd before and after the vitamin D2 source supplementation.

Diet Composition

The feed rations contained corn silage, grass round bale silage, PMR mash, and a Robot pellet. The mash and pellet were comprised of barley grain, corn distillers, canola meal, nutriments, beet pulp, fat, minerals, and vitamins and, for the treatment rations, the inactive yeast comprising vitamin D2. No other additives such as antibiotic, ionophores, direct fed microbial and/or enzymes were added to the ration. The diet composition and nutritional value of the feed rations for which milk data is presented are shown in Table 1.

TABLE 1
Cows partial mixed ration ingredients and nutritional composition.

| Vitamin D2 | | 400 000 | 500 000 | 600 000 | 650 000 | 750 000 | 800 000 | 850 000 | 900 000 | 950 000 | 1 000 000 |
|---|---|---|---|---|---|---|---|---|---|---|---|
| IU/cow/day | Control | IU | IU | IU | IU | IU | IU | IU | IU | IU | IU |
| Corn silage, | 8.64 | 8.64 | 9.32 | 6.86 | 7.13 | 7.08 | 5.19 | 5.96 | 5.96 | 5.96 | 6.44 |
| kg DM/cow/day | | | | | | | | | | | |
| Grass silage, | 2.24 | 3.68 | 3.55 | 4.02 | 3.97 | 4.58 | 6.51 | 5.89 | 3.53 | 3.59 | 4.00 |
| kg DM/cow/day | | | | | | | | | | | |
| Mash, kg | 5.50 | 5.51 | 5.47 | 5.49 | 5.45 | 5.86 | 5.82 | 5.85 | 5.85 | 5.85 | 5.85 |
| DM/cow/day | | | | | | | | | | | |
| Robot pellet, | 4.04 | 4.04 | 4.47 | 4.83 | 4.72 | 4.72 | 5.16 | 5.17 | 5.18 | 5.18 | 5.18 |
| kg DM/cow/day | | | | | | | | | | | |
| Dry matter | 44.89 | 48.85 | 40.02 | 46.72 | 44.96 | 42.31 | 52.11 | 43.83 | 42.62 | 41.47 | 44.79 |
| (DM), % | | | | | | | | | | | |
| Crude protein | 14.46 | 14.69 | 13.78 | 14.74 | 14.50 | 14.40 | 14.27 | 14.07 | 15.71 | 17.10 | 16.11 |
| (CP), % DM | | | | | | | | | | | |
| Neutral detergent | 36.56 | 37.89 | 35.36 | 36.07 | 36.26 | 36.43 | 36.71 | 37.12 | 34.44 | 33.32 | 34.71 |
| fiber (NDF), % DM | | | | | | | | | | | |
| Acid detergent | 21.73 | 22.78 | 20.04 | 20.63 | 20.29 | 20.02 | 20.31 | 21.74 | 20.18 | 19.36 | 20.07 |
| fiber (ADF), % DM | | | | | | | | | | | |
| Non fiber | 34.01 | 32.55 | 37.72 | 34.55 | 35.51 | 36.82 | 36.75 | 36.07 | 36.68 | 34.76 | 35.46 |
| carbohydrate | | | | | | | | | | | |
| (NFC), % DM | | | | | | | | | | | |
| Calcium | 1.03 | 1.04 | 0.87 | 0.94 | 0.79 | 0.75 | 0.57 | 0.54 | 0.58 | 0.58 | 0.57 |
| (Ca), % DM | | | | | | | | | | | |
| Phosphorous | 0.51 | 0.50 | 0.48 | 0.52 | 0.51 | 0.43 | 0.46 | 0.47 | 0.53 | 0.57 | 0.51 |
| (P), % DM | | | | | | | | | | | |

Feed Manufacture and Treatment Groups in the Trial

The inactivate yeast comprising vitamin D2, e.g., yeast provided by Lallemand, Inc. of Montreal, Canada, has a vitamin D2 concentration of 20, 000, 000 IU/kg and was included in the mash. The ration was modified to increasing amounts of vitamin D2 from inactive yeast from a rate of 0 to 1 000 000 IU/day, according to the schedule detailed in Table 2. In addition, each cow received a daily dose of 31000 IU/day of vitamin D3.

TABLE 2
Vitamin D2 incremental (IU/day) increase in the diet

| Date | Increment | Diet vitamin D2 content |
|---|---|---|
| Jan. 1, 2011 | 100 000 | 100 000 |
| Feb. 1, 2011 | 100 000 | 200 000 |
| Mar. 1, 2011 | 100 000 | 300 000 |
| Mar. 29, 2011 | 100 000 | 400 000 |
| May 1, 2011 | 100 000 | 500 000 |
| Jun. 6, 2011 | 100 000 | 600 000 |
| Sep. 8, 2011 | 50 000 | 650 000 |
| Oct. 1, 2011 | 50 000 | 700 000 |
| Nov. 11, 2011 | 50 000 | 750 000 |
| Jun. 15, 2012 | — | 750 000 |
| Jul. 17, 2012 | 50 000 | 800 000 |
| Aug. 21, 2012 | 50 000 | 850 000 |
| Sep. 20, 2012 | 50 000 | 900 000 |
| Nov. 7, 2012 | 50 000 | 950 000 |
| Dec. 7, 2012 | 50 000 | 1 000 000 |
| Nov. 7, 2013 | — | 1 000 000 |

Feeding Method/System

Cows were fed once a day a partial mixed ration with a portion of grain fed through a voluntary (robotic) milking system. This grain based concentrate did not contain any inactive yeast comprising vitamin D2. The mixed ration prepared on farm and the mash was thoroughly mixed for 15 minutes. Cows had free access to the feed (5% orts) and water.

Description of Parameters Recorded

Milk production (measured daily on an individual basis), Somatic cells count (SCC), butterfat, and protein were measured at least once per week for the group. Milk samples were collected at specific period and analyzed for vitamin D. Serum samples from 10 selected cows were collected at the end of the 500 000 IU/day period, after one month at 750 000 IU/day, after 7 months of 750 000 IU/day and after 9 months at 1 000 000 IU/day supplementation for 25(OH) D, calcium, and phosphorus. Reproductive health checks were also conducted monthly.

Description of methods used including for evaluating:

The Feed Additive Itself

Vitamin D (lack of a subscript implies both Vitamin D₂ and Vitamin D₃) is extracted and isolated by HPLC. Then, vitamin D₂ and Vitamin D₃ are quantified by comparison of the UV peak areas of standards.

Manufactured Feed Containing the Feed Additive

The same technique used for the additive is applied for the feed or the milk.

Parameters Recorded

Vitamin D2, vitamin D3, 25(OH) D were analyzed in the milk and the serum of the cows. The conversion into international unit (IU) was done as follows:

25(OH)D in IU/100 g=25(OH)D in ng/100 g/25

Total vitamin D content was calculated as follows:

Total vitamin D content in the milk (IU/100 g)=vitamin D2 (IU/100 g)+vitamin D3 (IU/100 g)+25(OH)D (IU/100 g).

Total vitamin D content in a 250 ml milk serving (IU)=total vitamin D content in the milk (IU/100 g)×2.5×1.03 (milk density).

Serum calcium and phosphorus were measured in 10 chosen cows after 500 000, 750 000 and 1 000 000 daily IU supply and were reported in mg/dL.

Other Parameters (Controlled)

Health Care During the Trial

The herd manager observed the cows on a daily basis and monitored their activity in the barn. Scheduled health checks were conducted by a veterinarian every 2 weeks.

Control of Disease Outbreaks During the Trial

Production and health of cows were monitored daily by the herd manager and health incidences were addressed immediately with consultation of a veterinarian.

Measures Taken to Avoid Cross-Contamination Between Experimental Groups

The pre-trial period was without adding the test additive in the diet for the whole herd. The test period corresponded to the irradiated yeast supplementation to all the cows; hence no cross-contamination was possible between treatments.

Results

Milk Production

From the pre-trial month (December 2010) with no added vitamin D2 from inactive yeast comprising vitamin D2 until the end of the next year reaching 1 000 000 IU/day/cow of vitamin D2 from inactive yeast comprising vitamin D2, cow average milk production followed a normal pattern.

Milk Vitamin D Content

The data from the monthly sampling of the pooled milk from the feeding of 400 000 IU/cow/day up to 1 000 000 IU/cow/day is reported in Table. As shown in Table 3, certain amounts of vitamin D2 yeast supplementation are not only correlated with an increase in vitamin D2 content of the milk, but also with an increase in vitamin D3 content and/or 25(OH) D content of the milk.

TABLE 3
Vitamin D2, D3, 25(OH) D and total vitamin D in the milk
according to the vitamin D2 yeast supplementation.

| | D2 | D3 | D2 + D3 | 25(OH) D | 25(OH) D | Total D | Total D |
|---|---|---|---|---|---|---|---|
| Feed rate | IU/100 g | IU/100 g | IU/100 g | ng/100 g | IU/100 g | IU/100 g | IU/250 ml |
| 400,000 D2 | 8.8 | 1.5 | 10.3 | 21 | 0.84 | 11.14 | 28.68 |
| 500,000 D2 | 9 | 1.2 | 10.2 | 24 | 0.96 | 11.16 | 28.74 |
| 600,000 D2 | 12.4 | 0.8 | 13.2 | 32 | 1.28 | 14.48 | 37.29 |
| 650,000 D2 | 9.6 | 0.8 | 10.4 | 32 | 1.28 | 11.68 | 30.08 |
| 750,000 D2^{a} | 26 | 4.58 | 30.58 | 38.1 | 1.54 | 32.12 | 82.71 |
| 750,000 D2^{b} | 21.3 | 4.39 | 25.69 | 40.7 | 1.63 | 27.32 | 70.34 |
| 850 000 D2 | 26.30 | 1.10 | 27.40 | 37.50 | 1.50 | 28.90 | 74.42 |
| 900 000 D2 | 25.60 | <2.0 | <27.60 | 25.70 | 1.03 | 28.63 | 73.72 |
| 1 000 000 D2^{c} | 15.80 | 0.70 | 16.50 | 49.00 | 1.96 | 18.46 | 47.53 |
| 1 000 000 D2^{d} | 38.70 | 1.80 | 40.50 | 48.90 | 1.96 | 42.46 | 109.32 |

^{a}after 1 month of supplementation;
^{b}after 8 months of supplementation;
^{c}after 1 months of supplementation;
^{d}after 12 months of supplementation

Besides the high level of supplementation, the final animal produce still meets the health requirements for the consumer.

Plasma Calcium and Phosphorus Content

The mineral blood status of the cows indicated that the vitamin D2 supply did not disturb the calcium and phosphorus metabolism because the observed levels remained within normal limits (8.5<Ca<11 mg/dL; 4<P<7 mg/dL).

The results show that feeding inactive yeast comprising vitamin D2 is effective to naturally enhance milk with vitamin D. The data also shows that feeding levels as high as 1 000 000 IU/day is safe for lactating dairy cows.

### Example 2

### Preparation of Cheese Comprising Vitamin D2

Different types of cheese were prepared with milk from cows fed with a composition comprising a cow feed and inactive yeast comprising vitamin D2 in accordance with the present disclosure. The different cheeses were prepared in accordance with techniques known to one skill in the art. For comparative purposes, one type of cheese (Mozzarella) was made with conventional milk. The amount of vitamin D (IU/100 g) in the cheeses was analyzed using the official methods of analysis of AOAC INTERNATIONAL, Current Ed., Method 2011.11, AOAC INTERNATIONAL, Gaithersburg, Md., USA.

TABLE 4
Vitamin D content for each cheese made in
accordance with the present disclosure.

| | Daily dose of | | |
|---|---|---|---|
| | vitamin | Total vitamin D | % DV per serving |
| Cheese | D2/cow/day | IU/100 g | of 50 g* |
| Bocconcini | 650 000 IU | 65 | 16 |
| Cheddar | 1 000 000 IU | 161 | 40 |
| Feta | 750 000 IU | 69 | 17 |
| Mozzarella | 0 IU (conventional | 5.3 | 1 |
| | milk) | | |
| Mozzarella | 650 000 IU | 83 | 21 |
| Ricotta | 650 000 IU | 42 | 11 |

*recommended serving portion by Canada's Food Guide (Health Canada)

### Example 3

### Preparation of Yogurt Comprising Vitamin D2

A plain yogurt comprising vitamin D was prepared as follows: the milk from cows fed with a composition comprising a cow feed and inactive yeast comprising vitamin D2 was standardized. The daily dose of vitamin D2 was 750 000 IU/cow. Vitamins other than vitamin D were added to the standardized vitamin D milk. Skim milk powder and Protelac™ were added to the standardized vitamin D milk. The standardized vitamin D milk containing the added powder ingredients was homogenized at about 2100 PSI. The homogenized vitamin D milk was pasteurized at a temperature of at least 85° C. The pasteurized vitamin D milk was cooled at a temperature of about 41-42° C. under agitation. The bacterial and probiotic cultures were added to the pasteurized vitamin D milk under agitation at a temperature of about 41-42° C. The pasteurized vitamin D milk containing the bacterial and probiotic culture was incubated for about 3.5 to about 5 hours at a temperature of about 41-42° C. to a pH of between about 4.3 and about 4.7 to form the vitamin D yogurt. The yogurt was cooled.

The amount of vitamin D (IU/100 g) in the yogurt was analyzed using the official methods of analysis of AOAC INTERNATIONAL, Current Ed., Method 2011.11, AOAC INTERNATIONAL, Gaithersburg, Md., USA. The vitamin D content of the yogurt was 35 IU/100 g. Considering that the serving size for yogurt can be, for example, between about 125 g and about 225 g, the yogurt prepared in accordance with the present disclosure had between about 22% and about 40% of the Daily Value of vitamin D per serving.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and as may be applied to the essential features hereinbefore set forth, and as follows in the scope of the appended claims.

What is claimed is:

1. A dairy product comprising vitamin D made with milk from dairy animals fed with a composition comprising a dairy animal feed and inactive yeast comprising vitamin D2.

2. The dairy product according to claim 1, wherein the dairy product comprising vitamin D is cheese, yogurt, cream cheese, cream, butter or ice cream.

3. The dairy product according to claim 1 or 2, wherein the dairy product comprising vitamin D is cheese.

4. The dairy product according to claim 1 or 2, wherein the dairy product comprising vitamin D is yogurt.

5. A method of increasing vitamin D content in a dairy product comprising orally administrating a feed composition comprising a dairy animal feed and inactive yeast comprising vitamin D2 to dairy animals.

6. The method according to claim 5, wherein the dairy product is cheese, yogurt, cream cheese, cream, butter or ice cream.

7. A method of manufacturing cheese comprising vitamin D, the method comprising coagulating milk from dairy animals fed with a composition comprising a dairy animal feed and inactive yeast comprising vitamin D2 to form a curd-whey mixture that is used to form the cheese.

8. The method of claim 7, further comprising separating curd from the curd-whey mixture to form the cheese comprising vitamin D.

9. The method according to claim 8 further comprising a step of cooking the curd to form the cheese comprising vitamin D.

10. The method according to claim 7, further comprising a step of acidifying the milk prior to the coagulation step.

11. A cheese comprising vitamin D obtained by the method as defined in any one of claims 7 to 10.

12. A method of manufacturing yogurt comprising vitamin D, the method comprising the steps of fermenting milk from dairy animals fed with a composition comprising a dairy animal feed and inactive yeast comprising vitamin D2 to form the yogurt comprising vitamin D.

13. A yogurt comprising vitamin D2 obtained by the method as defined in claim 12.

14. A method of manufacturing a dairy product comprising vitamin D, the method comprising the steps of providing milk from dairy animals fed with a composition comprising a dairy animal feed and inactive yeast comprising vitamin D2; and processing the milk to form the dairy product comprising vitamin D.

15. The method according to claim 14, wherein the dairy product is cheese, yogurt, cream cheese, cream, butter or ice cream.
